(19) United States
(12) Patent Application Publication
(10) Pub. No.: US 2014/0253301 A1
(43) Pub. Date: Sep. 11, 2014

(54) COMMUNICATIONS DEVICE AND COMMUNICATIONS SYSTEM

(71) Applicant: KABUSHIKI KAISHA TOSHIBA, Tokyo (JP)

(72) Inventors: Noriyuki HIRAYAMA, Tokyo (JP); Satoshi ODAKURA, Tokyo (JP); Keiji SAITO, Tokyo (JP); Mayuko YOSHIDA, Tokyo (JP)

(73) Assignee: KABUSHIKI KAISHA TOSHIBA, Tokyo (JP)

(21) Appl. No.: 14/242,729

(22) Filed: Apr. 1, 2014

Related U.S. Application Data
(63) Continuation of application No. PCT/JP2013/056510, filed on Mar. 8, 2013.

(51) Int. Cl. G08C 17/02

(52) U.S. Cl. CPC G08C 17/02
USPC 340/12.54

(57) ABSTRACT

According to one embodiment, communications device includes receiver, transmitter, and display. The receiver receives, when first information indicating a setting on a target control device is displayed in a first color in a first display area of a display device, an operation for changing information displayed in the first display area from the first information to second information. The transmitter transmits to the target control device, after a first time has elapsed from when the receiver receives the operation, an instruction for changing the setting according to the second information. The display displays, when the receiver receives the operation for changing the information displayed in the first display area and before the transmitter transmits the instruction, the second information in a second color on the first display area, and displays, upon transmission of the instruction, the second information in a third color in the first display area.

### CROSS-REFERENCE TO RELATED APPLICATIONS

This application is a continuation of International Application No. PCT/JP2013/056510, filed Mar. 8, 2013, which designates the United States, the entire contents of which are incorporated herein by reference.

### FIELD

Embodiments described herein relate generally to a communications device and a communications system.

### BACKGROUND

Conventionally, there has been proposed remote controllers for operating home electric appliances and equipments. These remote controllers have been usually designed for each of home electric appliances and equipments according to the specifications thereof.

Information communications technologies have been increasingly developed in recent years. Some technologies have been developed for providing various services to general dwellers by coupling home electric appliances and equipments to a communications network to help controlling the home electric appliances and equipments. For example, with the development of information communications technologies, there have been generally known communications protocols such as an energy conservation and homecare network (ECHONET) Lite protocol that controls in-home appliances.

In the conventional technologies, however, the remote controllers for operating home electric appliances and equipments are exclusive for each of them. Therefore, usage of a remote controller for a plurality of types of home electric appliances and equipments has not been considered. In addition, sharing of a network for communications of a plurality of types of home electric appliances and equipment has not been discussed.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of an example of a household equipment communications system according to a first embodiment;

FIG. 2 is an exemplary view of an example of a household equipment communications system according to a modification of the first embodiment;

FIG. 3 is an exemplary block diagram of a hardware configuration of a portable communications terminal in the first embodiment;

FIG. 4 is an exemplary block diagram of a configuration of an operation application executed on the portable communications terminal in the first embodiment;

FIG. 5 is an exemplary view of an example of a screen displayed on a display device by a display controller in the first embodiment;

FIG. 6 is an exemplary view of an example of an air conditioner correspondence table stored in a non-volatile memory in the portable communications terminal in the first embodiment;

FIG. 7 is an exemplary flowchart of processing for changing temperature of a target control device performed in the portable communications terminal in the first embodiment;

FIG. 8 is an exemplary view of an example of a screen displayed by the display controller and on which the changed temperature is displayed in the first embodiment;

FIG. 9 is an exemplary view of an example of a screen displayed by the display controller after the color of the screen is changed by transmission of an instruction for changing the color as a trigger, in the first embodiment;

FIG. 10 is an exemplary view of an example of a screen displayed by the display controller and on which a message of failure of change is displayed, in the first embodiment;

FIG. 11 is an exemplary flowchart of processing performed in the portable communications terminal when a press operation of a button in a display area for switching modes is received, in the first embodiment;

FIG. 12 is an exemplary view of an example of a screen displayed by the display controller when an “AUTO” button is pressed, in the first embodiment;

FIG. 13 is an exemplary view of an example of a screen with an animation displayed by the display controller when an operation target is changed, in the first embodiment;

FIG. 14 is an exemplary view of an example of an operation screen for a water heater displayed by the display controller in the first embodiment;

FIG. 15 is an exemplary view of an example of a household equipment communications system according to a second embodiment; and

FIG. 16 is an exemplary view of an example of an operation screen for an illumination lamp displayed by the display controller in a portable communications terminal in the second embodiment.

### DETAILED DESCRIPTION

In general, according to one embodiment, a communications device comprises a receiver, a transmitter, and a display. The receiver is configured to receive, when first information indicating a setting on a target control device targeted for operation is displayed in a first color in a first display area of a display device, an operation for changing information displayed in the first display area from the first information to second information. The transmitter is configured to transmit to the target control device, after a first time has elapsed from when the receiving module has received the operation, an instruction for changing the setting according to the second information. The display is configured to display, when the receiver has received the operation for changing the information displayed in the first display area and before the transmitter transmits the instruction, the second information in a second color different from the first color in the first display area, and to display, upon transmission of the instruction by the transmitter, the second information in a third color different from the second color in the first display area.

### First Embodiment

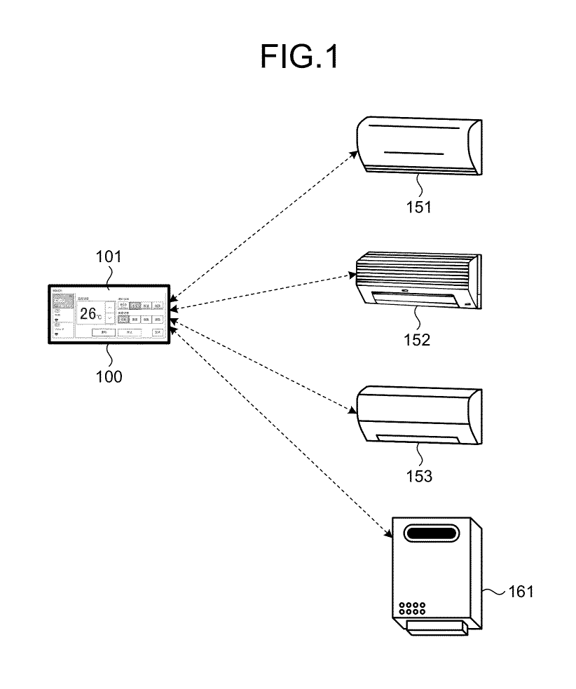

FIG. 1 is a view of a household equipment communications system according to a first embodiment. As illustrated in FIG. 1, a first air conditioner 151, a second air conditioner 152, a third air conditioner 153, and a water heater 161 are installed in a house. The first air conditioner 151, the second air conditioner 152, and the third air conditioner 153 may be installed in the same room or in different rooms. In addition, the first air conditioner 151, the second air conditioner 152, and the third air conditioner 153 may be the same model or different models, and may be produced by the same manufacturer or different manufacturers.

In the household equipment communications system according to the embodiment, a portable communications terminal controls the first air conditioner 151, the second air conditioner 152, the third air conditioner 153, and the water heater 161 through a wired or wireless network.

An operation application is installed in advance in a portable communications terminal 100 according to the embodiment. An operation application is used for operating the equipment such as the first air conditioner 151, the second air conditioner 152, the third air conditioner 153, and the water heater 161 in a versatile manner. The authentication between the operation application and the equipment may be set using a conventionally developed method, therefore, the description thereof is omitted here.

Users can operate the first air conditioner 151, the second air conditioner 152, the third air conditioner 153, and the water heater 161 by operating a display device 101 comprising a touch panel in the portable communications terminal 100.

In the embodiment illustrated in FIG. 1, the portable communications terminal 100 is connected to each of the first air conditioner 151, the second air conditioner 152, the third air conditioner 153, and the water heater 161 using a Bluetooth (registered trademark) connection. In addition, an ECHONET Lite communications protocol is used for a communications protocol on a higher layer than the Bluetooth (registered trademark) layer in the embodiment.

The ECHONET Lite communications protocol is a protocol developed for controlling household appliances and equipments in an integrated manner in an energy control system called a home energy management system (HEMS). The communications protocol in the embodiment is not limited to the ECHONET Lite, however, and other communications protocols may be used.

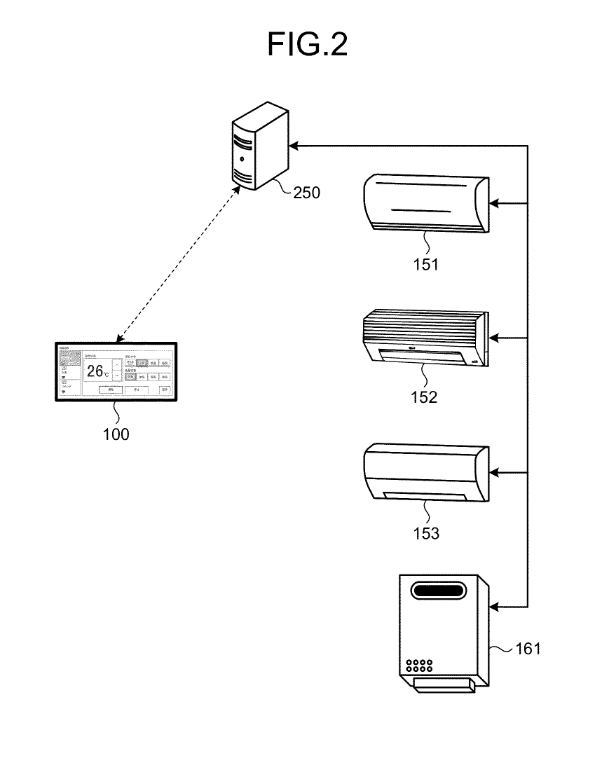

The communications protocol for the lower layer than the ECHONET Lite layer is not limited to a specific protocol in the embodiment. For example, the Bluetooth (registered trademark) in the embodiment may be substituted with an IEEE802.11b/g/n or IEEE802.15.4 protocol. FIG. 2 is a view of a household equipment communications system according to a modification of the first embodiment. In the example illustrated in FIG. 2, the portable communications terminal 100 wirelessly communicates with a wireless communications adapter 250. The wireless communications adapter 250 in turn communicates with the first air conditioner 151, the second air conditioner 152, the third air conditioner 153, and the water heater 161 coupled to the wireless communications adapter 250 through a wired connection (e.g., Ethernet (registered trademark)) or a wireless connection. This enables the portable communications terminal 100 to communicate with the first air conditioner 151, the second air conditioner 152, the third air conditioner 153, and the water heater 161 through the wireless communications adapter 250.

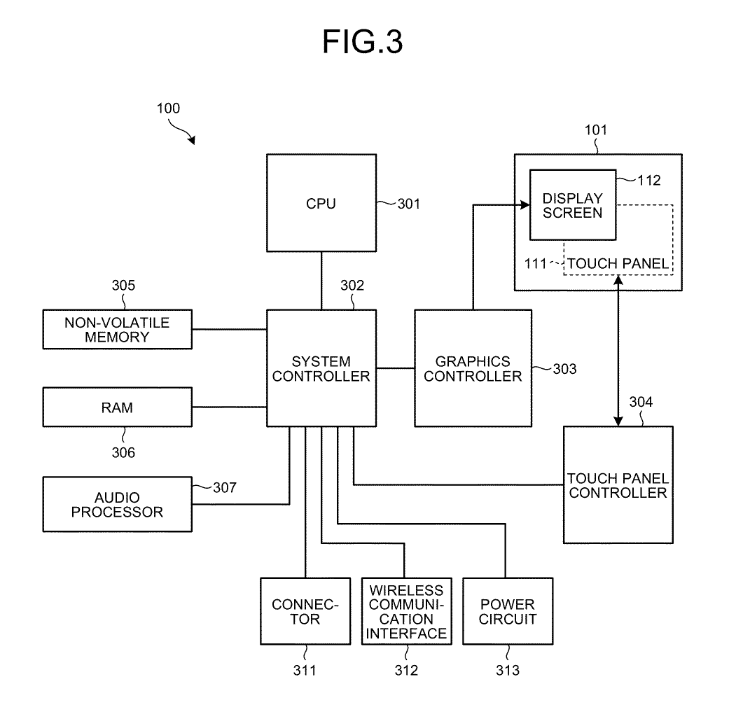

The following describes a configuration of the portable communications terminal 100 in the embodiment. FIG. 3 is a block diagram of a hardware configuration of the portable communications terminal 100 in the first embodiment. As illustrated in FIG. 3, the portable communications terminal 100 in the first embodiment comprises the display device 101, a central processing unit (CPU) 301, a system controller 302, a graphics controller 303, a touch panel controller 304, a non-volatile memory 305, a random access memory (RAM) 306, an audio processor 307, a connector 311, a wireless communications interface (I/F) 312, and a power circuit 313.

The display device 101 in the embodiment comprises a touch panel 111 and a display screen (display) 312 such as a liquid crystal display (LCD) and an organic light emitting display (OLED). The touch panel 111 has a function for detecting positional coordinates provided for and on a display screen 112. The touch panel 111 can detect the position touched by a finger of a user who holds the portable communications terminal 100, for example, on the display area on the display screen 112. The position is also called a touch position. As described above, the touch panel 111 enables the display screen 112 to function as a touch screen.

The system controller 302 comprises a memory controller that accesses and controls the non-volatile memory 305 and the RAM 306. The system controller 302 also comprises a function for communicating with the graphics controller 303. The system controller 302 further comprises a micro computer, in which embedded controllers are integrated. The embedded controllers control the power circuit 313 that supplies the electrical power stored in a battery (not illustrated).

The graphics controller 303 is a display controller of the portable communications terminal 100 that controls and displays images on the display screen 112 used for a display monitor of the portable communications terminal 100. The touch panel controller 304 controls the touch panel 111 to obtain coordinate data that indicate a touch position touched by a user on the display screen 112.

The audio processor 307 performs audio processing such as analog-to-digital conversion, noise removal, and echo cancellation on the audio signals input from a not-illustrated microphone, and inputs the processed audio signals to the CPU 301. The audio processor 307 also performs audio processing such as audio composition on audio signals and outputs the processed audio signals to a not-illustrated speaker under the control of the CPU 301, whereby audio output is performed using the speaker.

The connector 311 is a connection interface connectable to a wired network such as an Ethernet (registered trademark) network. The portable communications terminal 100 in the embodiment may be connected to appliances and equipments through a wired network.

The wireless communications I/F 312 is a wireless communications interface that is connected to the wireless communications adapter 250 or appliances and equipments using communications protocols such as the Bluetooth (registered trademark), IEEE802.11b/g/n, and IEEE802.15.4 protocols.

The CPU 301 is a processor that controls operations of the portable communications terminal 100 in an integrated manner. The CPU 301 therefore controls the modules and components of the portable communications terminal 100 through the system controller 302. In addition, the CPU 301 executes the operating system loaded from the non-volatile memory 305 to the RAM 306. The RAM 306 provides a working area as a main memory of the portable communications terminal 100 for the CPU 301 to execute the operating system or computer programs.

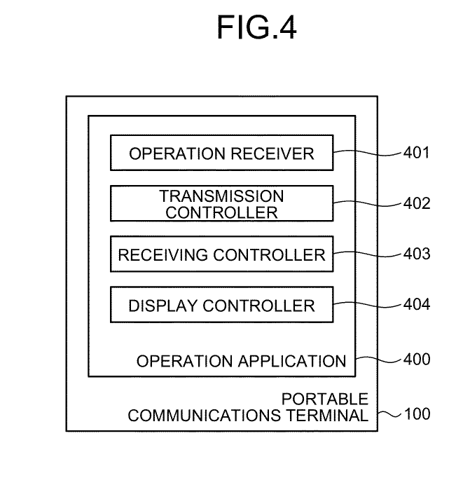

The CPU 301 executes an operation application on the operating system. FIG. 4 is a block diagram of a configuration of an operation application 400 executed on the portable communications terminal 100 according to the embodiment. As illustrated in FIG. 4, the operation application 400 comprises an operation receiver 401, a transmission controller 402, a receiving controller 403, and a display controller 404.

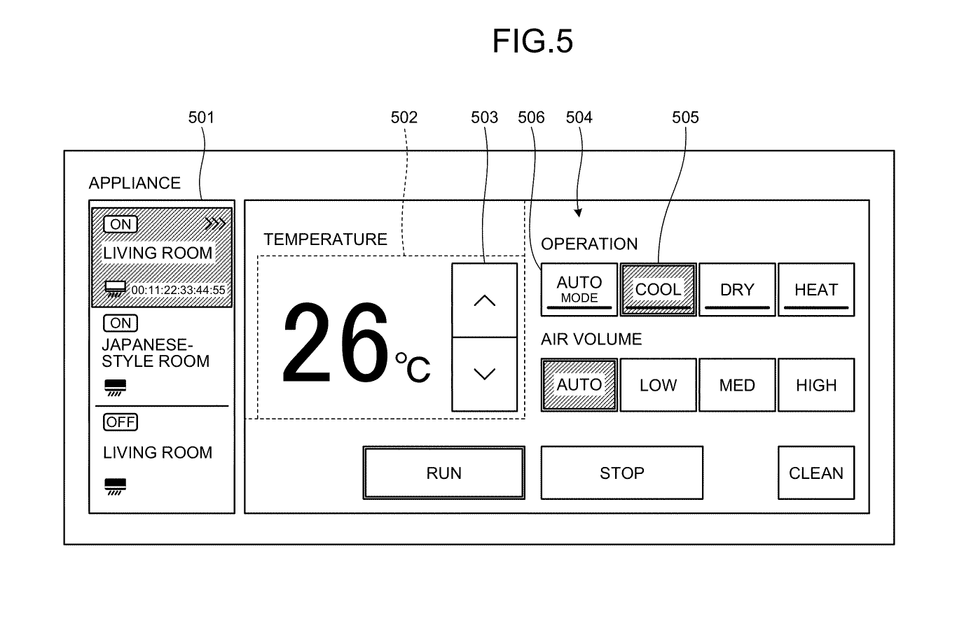

The display controller 404 performs control for displaying information on the display screen 112 of the display device 101. FIG. 5 is a view of a screen displayed on the display device 101 by the display controller 404. The example screen illustrated in FIG. 5 comprises a display area 501 for device selection to select an operation target device, a display area 502 for changing the temperature, and a display area 504 for switching modes. The various states of a target control device displayed in an example screen illustrated in FIG. 5 are based on the settings received by the receiving controller 403 from the target control device.

The display area 501 displays the following target appliances and equipments: an air conditioner in a living room (e.g., the first air conditioner 151); an air conditioner in a Japanese-style room (e.g., the second air conditioner 152); and an air conditioner in a living room (e.g., the third air conditioner 153).

The display area 502 displays the temperature currently set in an appliance selected in the display area 501, and a temperature change button 503 for changing the temperature of the selected appliance.

The display area 504 displays various types of modes available in the appliance selected by the display area 501, which can be switched to each other. For example, “AUTO”, “COOL”, “DRY”, and “HEAT” are displayed so that any one of them can be selected for switching operation mode of the appliance. For another example, “AUTO”, “LOW”, “MED”, and “HIGH” are displayed so that any one of them can be selected for switching the air volume. In addition, the display area 504 displays a “RUN” button for starting the operation, a “STOP” button for stopping the operation, and a “CLEAN” button. In the example illustrated in FIG. 5, a “COOL” 505 has been already set for the operation mode, and other operation modes including “AUTO” 506 are not set.

The display screen 112 displayed by the display controller 404 is a versatile operation screen for operating air conditioners.

The temperature range that can be set on air conditioners may differ depending on models of air conditioners. The portable communications terminal 100 in the embodiment, however, is a versatile communications terminal that complies with a communications protocol such as the ECHONET Lite protocol and is capable of operating a plurality of air conditioners. For that reason, specifications of air conditioners not yet known that will be released in the future need to be considered. The operation application 400 in the portable communications terminal 100 in the embodiment, therefore, is capable of receiving temperature changing operations using a slightly narrower temperature range than the usual temperature range that can be set for typical air conditioners.

The operation receiver 401 receives the operations related to the various types of settings displayed on the display screen 112. For example, the operation receiver 401 detects a touch on the display area for each air conditioner in the display area 501, thereby receiving a selection operation for selecting the corresponding air conditioner as an operation target.

For another example, the operation receiver 401 detects a touch on the temperature change button 503 in the display area 502, thereby receiving a change operation for changing the temperature of the air conditioner.

As described above, in the operation application 400 of the portable communications terminal 100, the temperature can be changed using a narrower temperature range than the temperature range available for setting on the various types of air conditioners (e.g., the first air conditioner 151, the second air conditioner 152, and the third air conditioner 153). If the operation receiver 401 receives a change operation by a user for changing the temperature to a temperature outside of the temperature range available for setting, the display controller 404 displays an error message.

In some cases, by using an infrared remote controller attached to an air conditioner, which is different from the portable communications terminal 100, the temperature of the first air conditioner 151, the second air conditioner 152, or the third air conditioner 153 may be set to a temperature outside of the temperature range available for being set by the display controller 404. For example, the temperature can be set in a range of 18 to 28° C. by the operation application while the temperature can be set in a range of 17 to 32° C. by the first air conditioner 151. As a result, the temperature has been set to 32° C. for the first air conditioner 151.

In such a case, the receiving controller 403 receives information that indicates the temperature currently set (32° C.) from the first air conditioner 151. The display controller 404 displays the temperature currently set, although it is outside of the temperature range available for setting. Various aspects can be considered as a change operation for changing the temperature after the temperature outside of the temperature range available for setting is displayed.

As one example of the embodiment, in the operation application 400, the temperature range available for setting may be enhanced depending on the temperature currently set for the first air conditioner 151. The temperature range that can be set may be enhanced because the portable communications terminal 100 stores therein the temperature ranges available for setting associated with the respective air conditioners. For example, when the operation application 400 detects that the temperature currently set is 32° C. on the first air conditioner 151, a range of 18 to 32° C. is stored in the portable communications terminal 100 as the temperature range available for setting for the first air conditioner 151. If the temperature ranges for setting differ depending on operation modes of the first air conditioner 151, the temperature range available for setting are stored in the portable communications terminal 100 associated with the respective operation modes.

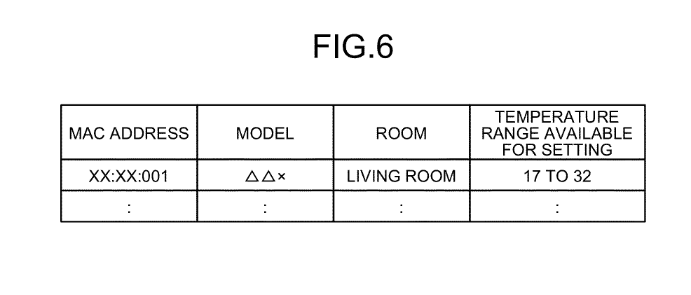

FIG. 6 is a view of an air conditioner correspondence table stored in the non-volatile memory 305 in the portable communications terminal 100 when the aspect of the embodiment is applied to. As illustrated in FIG. 6, a media access control (MAC) address, a model, a room, and the temperature range available for setting, are stored in association with each other in the non-volatile memory 305. When the temperature currently set is outside of the temperature range available for setting, the operation receiver 401 of the operation application 400 in the embodiment renews the temperature range available for setting so as to include the temperature currently set in the renewed temperature range. This achieves enhancing the temperature range available for setting.

As another example, the temperature range available for setting is not enhanced. In this case, the operation receiver 401 receives an operation for approximating the temperature currently set (e.g., 32° C.) to the temperature range available for setting (e.g., an operation to sequentially lower the temperature like to 31, 30, 29° C.). After that, however, the operation receiver 401 does not need to receive an operation for approximating the temperature to the temperature set before (e.g., 32° C.)

As still another example, when the operation receiver 401 receives an operation for changing the temperature currently set (e.g., 32° C.), the temperature may be changed to a temperature within the temperature range available for setting (e.g., 17 to 28° C.). After that, the operation receiver 401 does not need to receive an operation for returning the temperature to the temperature set before (e.g., 32° C.)

The transmission controller 402 transmits data to the target control devices such as the air conditioners (e.g., the first air conditioner 151, the second air conditioner 152, and the third air conditioner 153) and the water heater 161. For example, the transmission controller 402 transmits an instruction for switching the setting of the appliances according to the operation received by the operation receiver 401.

The receiving controller 403 receives data from any of the target control devices such as the air conditioners (e.g., the first air conditioner 151, the second air conditioner 152, and the third air conditioner 153) and the water heater 161. For example, the receiving controller 403 receives the current state of the target control device or the result of the instruction transmitted by the transmission controller 402.

In the conventional exclusive controller for the target control device, the target control device and the controller directly communicate with each other on a one-on-one basis using infrared communications, for example. Accordingly, the traffic of the communications path is so simple that it does not need to be worried about. By contrast, when a communications device (an operation application) capable of operating a plurality of target control devices, like in the embodiment, the relation between the target control device and the communications device is on a multipoint-to-multipoint basis. Accordingly, the traffic of the communications path needs to be shared with other communications device(s) and target control device(s). As a result, like a change operation for changing the temperature, pressing operations are repeated and thus a plurality of changing temperature instructions are transmitted, the traffic of the communications path may be increased.

In view of the circumstances described above, the transmission controller 402 in the embodiment transmits an instruction for changing the temperature is received after a predetermined time has elapsed from a time when a change operation for changing the temperature has received. In this case, a user can hardly recognize the current state of the target control device. Therefore, in the embodiment, displayed color representing the temperature is switched to another color according to the state, thereby enabling the user to recognize the state of the target control device.

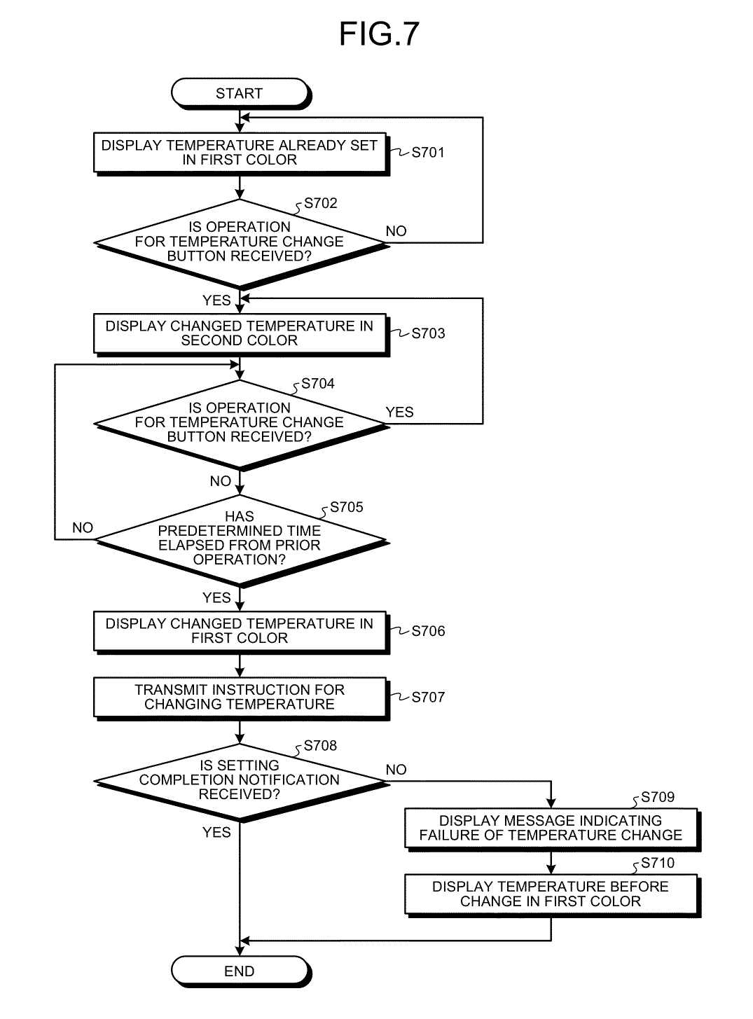

The following describes processing for changing the temperature of a target control device performed in the portable communications terminal 100 in the embodiment. FIG. 7 is a flowchart of processing procedures for changing the temperature of a target control device performed in the portable communications terminal 100 in the first embodiment.

As illustrated in FIG. 5, the display controller 404 firstly displays the temperature already set (e.g., 26° C.) in a first color on the display screen 112 of the display device 101 (S701). The first color is black, for example.

When the display controller 404 displays the temperature currently set that is one of the settings for the air conditioner 151, i.e., the target for operation, in the first color on the display area for changing the temperature 502 of the display device 101, the operation receiver 401 receives an operation for changing the temperature to another temperature through the temperature change button 503.

The operation receiver 401 then determines whether an operation for changing the temperature currently set to another temperature is received through the temperature change button 503 (S702). If the operation receiver 401 determines that the operation is not received (No at S702), the processing returns to S701.

If the operation receiver 401 determines that the operation for changing the temperature to another temperature is received through the temperature change button 503 (Yes at S702), the display controller 404 displays the changed temperature (e.g., 28° C.) in a second color different from the first color on the display area 502, before the transmission controller 402 transmits the instruction for changing the temperature to another temperature (S703). The second color is light gray, for example.

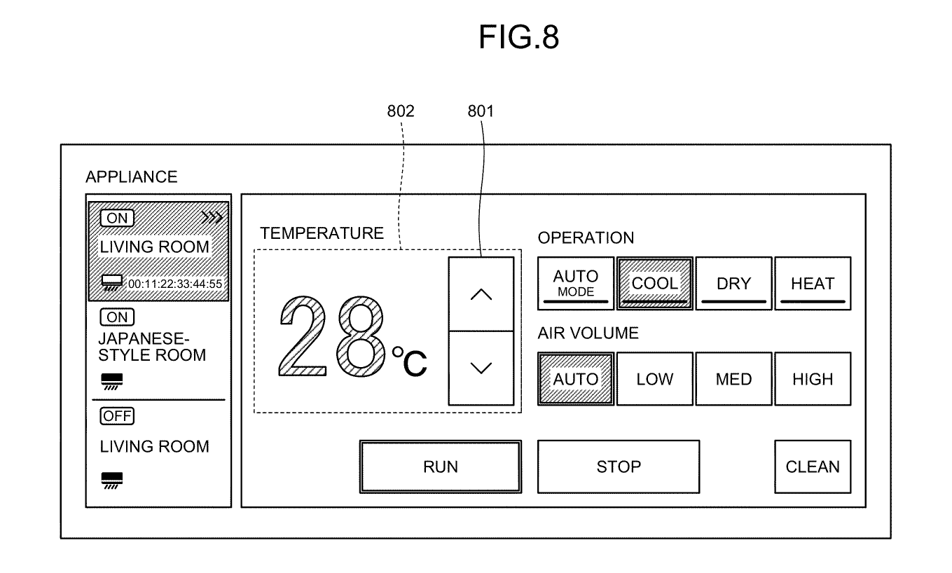

FIG. 8 is a view of an example screen displayed on the display device 101 by the display controller 404, on which the changed temperature is displayed. As illustrated in FIG. 8, the changed temperature (e.g., 28° C.) is displayed in a display area for changing the temperature 802 in a color different from the example screen illustrated in FIG. 5. After the temperature has changed, the temperature can still be changed through a temperature change button 801.

The operation receiver 401 therefore determines whether an operation for changing the temperature to another temperature is received through the temperature change button 801 (S704). If the operation receiver 401 determines that the operation is received (Yes at S704), the processing is performed from S703.

If the operation receiver 401 determines that the operation for changing the temperature to another temperature is not received (No at S704), the operation receiver 401 determines whether a predetermined time has elapsed (S705) after receiving an operation just before the change operation determined at S704. If the operation receiver 401 receives consecutive operations at S704, the operation receiver 401 determines whether a predetermined time has elapsed after receiving the last operation of the consecutive operations received at S704. The predetermined time is, for example, 3 seconds; however, any value of time may be set according to an aspect of the embodiment. If the operation receiver 401 determines that a predetermined time has not elapsed (No at S705), the processing is repeated from S704.

If the operation receiver 401 determines that the predetermined time has elapsed, (Yes at S705), the display controller 404 displays the changed temperature (e.g., 28° C.) on the display area for changing the temperature 802 in the first color different from the second color (S706).

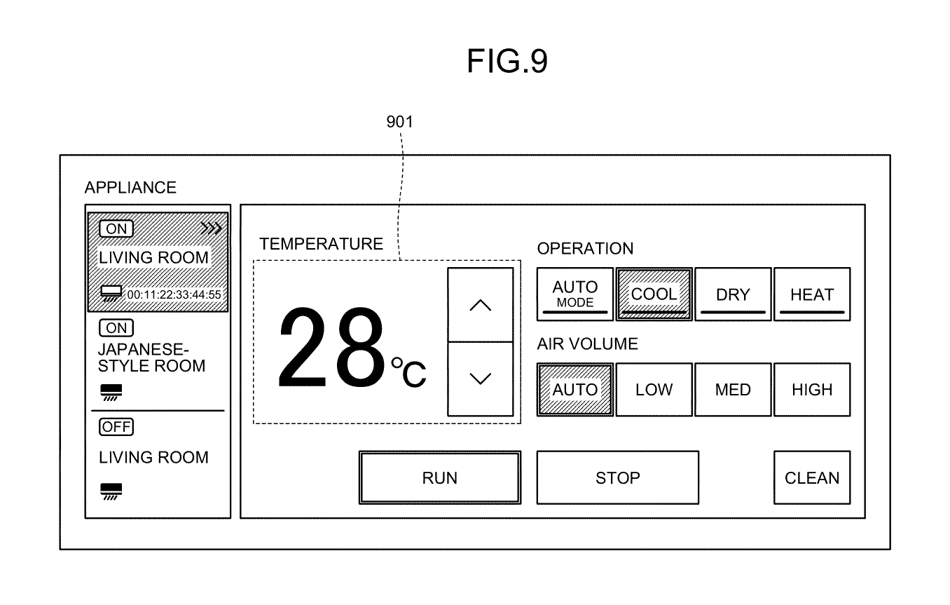

FIG. 9 is a view of an example screen displayed on the display device 101 by the display controller 404 after the color on the screen is changed by transmission of an instruction as a trigger. As illustrated in FIG. 9, the changed temperature (e.g., 28° C.) is displayed in a display area 901 for changing the temperature in the same color as the example screen illustrated in FIG. 5 and in a different color from the example screen illustrated in FIG. 8. Displaying the temperature in different colors like this enables the user to recognize the transmission of the instruction to the target control device.

After the predetermined time has elapsed from the time when the operation receiver 401 has received an operation for changing the temperature, the transmission controller 402 transmits an instruction for changing the setting according to the changed temperature to the target control device (e.g., the first air conditioner 151) (S707). In the processing flow, the portable communications terminal 100 performs the processing in the order from S706 to S707; however, the portable communications terminal 100 may perform the processing in the reversed order, i.e., from S707 to S706.

After the transmission controller 402 transmitted the instruction, the receiving controller 403 determines whether a setting completion notification is received from the target control device (e.g., the first air conditioner 151), which indicates that the setting corresponding to the transmitted instruction is completed (S708). If the receiving controller 403 determines that the setting completion notification is received (Yes at S708), the processing ends.

If the receiving controller 403 determines that the setting completion notification is not received, (No at S708), the display controller 404 displays a message indicating that the change of the temperature failed (S709).

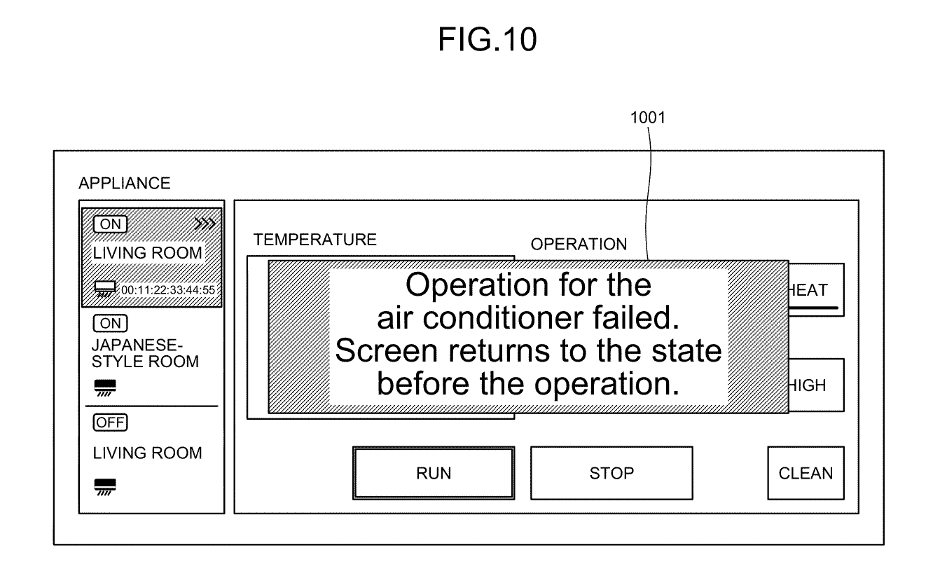

FIG. 10 is a view of an example screen displayed by the display controller 404, on which a message of failure of change is displayed. The message “Operation for the air conditioner failed. Screen returns to the state before the operation.” is displayed on a window 1001 as illustrated in FIG. 10. This enables the user to recognize that the change of the temperature failed.

After that, the display controller 404 displays the temperature before the change in the first color (S710). As a result, a screen like the one illustrated in FIG. 5, for example, is displayed.

In the first embodiment, by performing the above-described processing, if the temperature change button is pressed more than once, only an instruction for changing the current temperature to the temperature set by the last press by a user is transmitted. This reduces the load on the network. In addition, changing the color for displaying the temperature using the above-described procedures enables the user to recognize the current state of the target control device.

In the above-described processing, when the instruction for changing the temperature is transmitted, the color for displaying the temperature is returned to the first color. However, the embodiment is not limited to this example. As a modification of the embodiment, the display controller 404 may change the color for displaying the temperature to a third color, which is dark gray, for example.

In the modification, displaying the temperature in the third color enables the user to recognize the transmission of the instruction to the target control device. In addition, when the receiving controller 403 receives the setting completion notification, the display controller 404 changes the color for displaying the changed temperature to the first color, in the modification. This enables the user to recognize the completion of setting of the target control device (the first air conditioner 151). The method for changing the color for displaying the temperature is not limited to the embodiment or modification described above. Various types of combinations of method for changing the color for displaying the temperature may be conceived according to an aspect of the embodiment.

In the temperature setting of the air conditioner in the portable communications terminal 100, when the temperature changed by the temperature change button 503 is the same as the temperature before being changed, the transmission controller 402 does not need to transmit the instruction for changing the temperature to the target control device (e.g., the first air conditioner 151).

In the above-described processing, the temperature is changed. However, the information operated with the portable communications terminal 100 is not limited to the temperature. For example, pressing a button displayed on the display area for switching modes 504 illustrated in FIG. 5 enables various settings. The button displayed on the display area for switching modes 504 does not need to be pressed more than once, unlike the temperature change button 503, the processing is different from the processing when the temperature change button 503 is pressed.

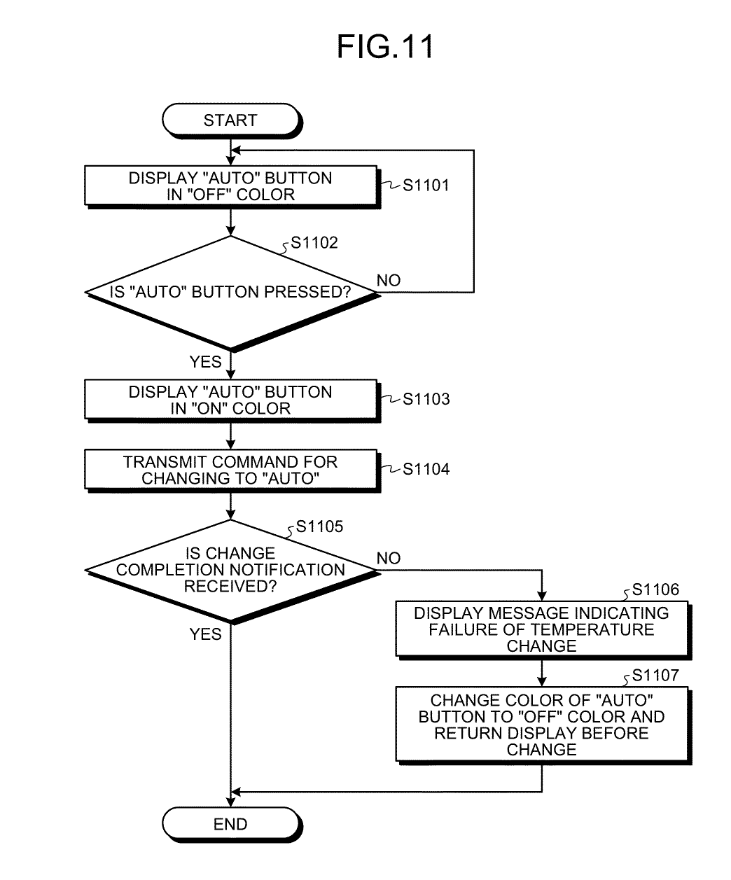

The following describes, therefore, the processing performed when the button displayed on the display area for switching modes 504 is pressed. FIG. 11 is a flowchart of the above-described processing in the portable communications terminal 100 in the first embodiment. In the example illustrated in FIG. 11, the “AUTO” button is pressed. When any one of other buttons on the display area for switching modes 504 (e.g., the “DRY” button and the “HEAT” button) is pressed, similar processing is performed, thus descriptions of the processing related to other buttons are omitted.

As illustrated in FIG. 5, the display controller 404 firstly displays the “AUTO” button on the display screen 112 of the display device 101 in a color indicating the “OFF” state of the mode (S1101). The color indicating the “OFF” state of the mode is white, for example. As illustrated in FIG. 5, the “COOL” button is displayed in a color indicating the “ON” state of the mode because a cooling mode has been set in the target control device (e.g., the first air conditioner 151). The color indicating the “ON” state of the mode is dark gray, for example. In this example, the color indicating the “ON” state of the mode and another color indicating the “OFF” state of the mode are used in common among the different buttons. However, different colors for the “ON” state and different colors for the “OFF” state may be used for each button.

The operation receiver 401 subsequently determines whether the “AUTO” button is pressed (S1102). If the operation receiver 401 determines that the “AUTO” button is not pressed (No at S1102), the processing is performed from S1101.

If the operation receiver 401 determines that the “AUTO” button is pressed (Yes at S1102), the display controller 404 displays the “AUTO” button in the color indicating the “ON” state of the mode (S1103) and the “COOL” button in the color indicating the “OFF” state of the mode.

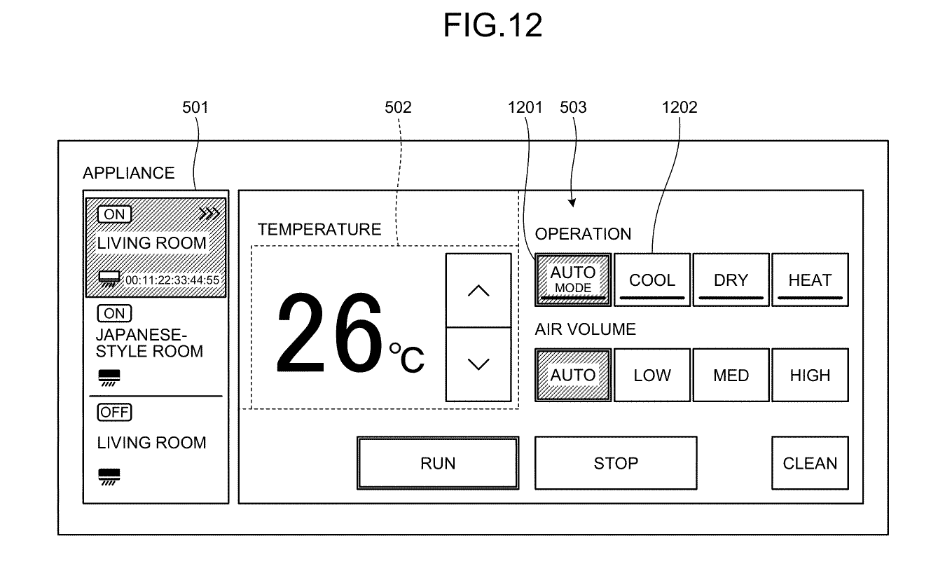

FIG. 12 is a view of an example screen displayed on the display device 101 by the display controller 404 after the “AUTO” button is pressed. As illustrated in FIG. 12, an “AUTO” button 1201 is set and a “COOL” button 1202 is not set.

After that, the transmission controller 402 transmits a command (instruction) for changing the mode to “AUTO” to the target control device (e.g., the first air conditioner 151) (S1104).

The receiving controller 403 then determines whether a change completion notification is received, which indicates that the change is completed (S1105). If the receiving controller 403 determines that the change completion notification is received (Yes at S1105), the processing ends.

If the receiving controller 403 determines that the change completion notification is not received (No at S1105), the display controller 404 displays a message indicating that the change of the mode failed (S1106). As a result, the example screen illustrated in FIG. 10 is displayed.

After that, the display controller 404 changes the color of the “AUTO” button to the color indicating the “OFF” state of the mode and returns the setting to the setting before the change (the “COOL” button is set as illustrated in FIG. 5) and displays the “COOL” button (S1107).

In the above-described processing, the color of the pressed button is changed on the display device 101 before receiving the change completion notification from the target control device and before transmitting the command for changing the mode to the target control device. This is because when the color of the button that a user pressed does not change immediately, the user may misunderstand that the portable communications terminal 100 did not recognize the user's operation and repeatedly press the same button. By suppressing the repeated pressing on the same button as described above, the load on the processing of the operation application 400 can be suppressed.

In the operation application 400 in the embodiment, when the operation of the target control device (e.g., an air conditioner) failed, an error message is displayed and the screen returns to the state before the operation. As a result, the state of the target control device (the air conditioner) matches the state displayed on the portable communications terminal 100. This is more convenient than the conventional exclusive controllers for the appliances.

In the portable communications terminal 100 in the embodiment, the operation receiver 401 receives a press operation on respective areas of target control devices on the display area for selecting an appliance 501, thereby changing the target for operation. On this occasion, an animation display is used so that the display area for selecting an appliance 501 and the display area for changing the temperature 502 move in a sliding manner.

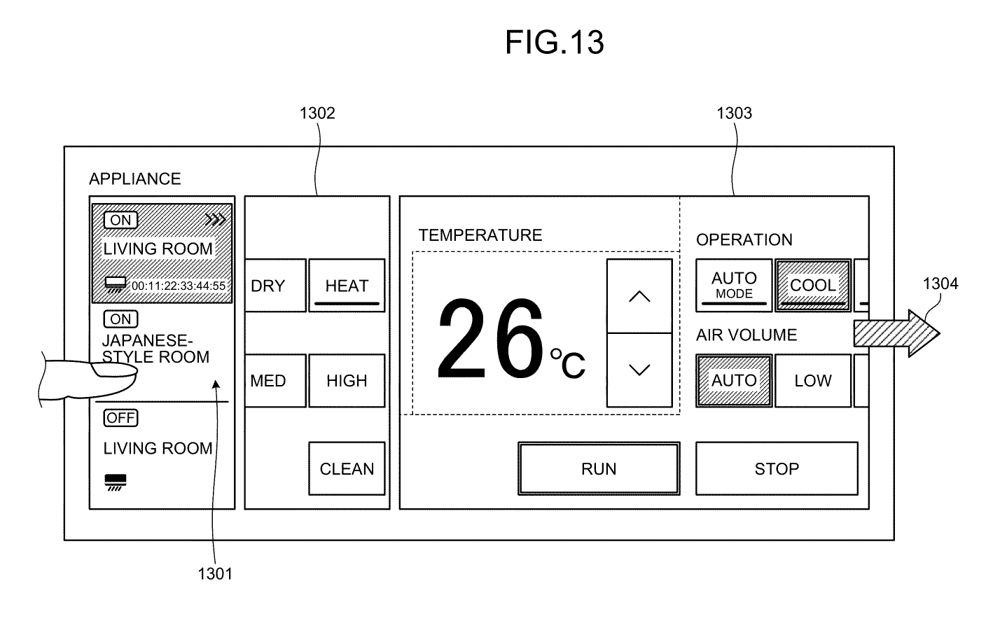

FIG. 13 is a view of example screen with an animation displayed by the display controller 404 when the operation target is switched to another appliance. As illustrated in FIG. 13, when a display area 1301 indicating the air conditioner in a Japanese-style room (e.g., the second air conditioner 152) is pressed, an operation screen 1303 indicating the air conditioner that was the operation target slides to the right, in the direction represented with an arrow 1304. In this animation display, the operation screen 1303 disappears from the display screen 112 and an operation screen 1302 indicating the air conditioner that will be the operation target slides to the right, in the direction represented with the arrow 1304, and is arranged on the display screen 112.

In the embodiment, using the animation display as described above enables the user to visually recognize that the target control device targeted for the operation is switched to another target control device.

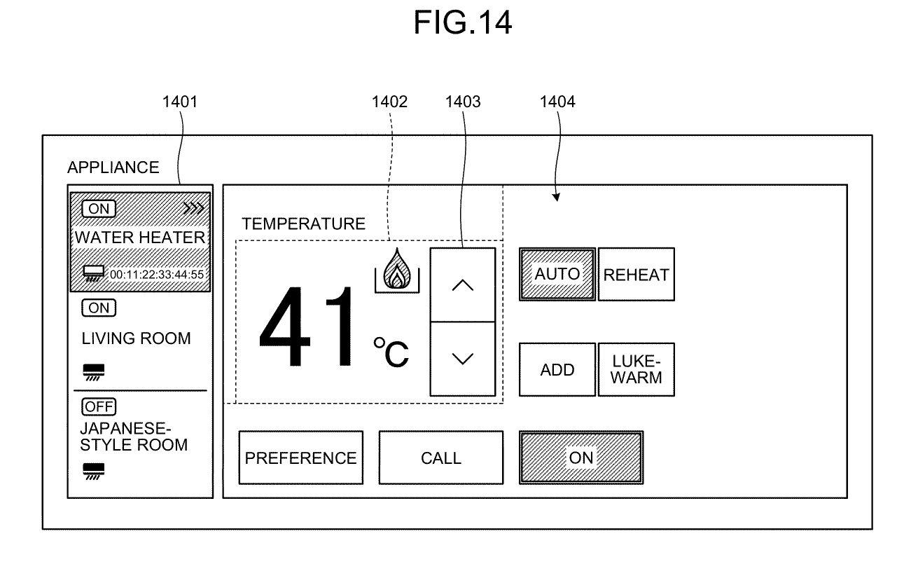

In addition, the operation application 400 of the portable communications terminal 100 is capable of displaying a screen for operating other types of appliance. FIG. 14 is a view of an example of an operation screen for the water heater 161 displayed by the display controller 404. The example screen illustrated in FIG. 14 comprises a display area for selecting an appliance 1401, a display area for changing a temperature 1402, and a display area for switching modes 1404.

In the operation application 400, processing performed when a temperature change button 1403 displayed in the display area for changing the temperature 1402 is operated is the same as the processing procedures illustrated in FIG. 7. In the same manner, processing procedures performed when an operation is performed in the display area for switching modes 1404 is the same as the processing procedures illustrated in FIG. 11. The first to third colors used for the screen for controlling the air conditioners may be the same as the first to third colors used for the screen for controlling the water heater. Alternatively, the first to third colors used for the screen for controlling the air conditioners may differ from the first to third colors used for the screen for controlling the water heater. In the same manner, the color indicating the “ON” state of the mode and the color indicating the “OFF” state of the mode used for the screen for controlling the air conditioners may be the same as the color indicating the “ON” state of the mode and the color indicating the “OFF” state of the mode used for the screen for controlling the water heater. Alternatively, the color indicating the “ON” state of the mode and the color indicating the “OFF” state of the mode used for the screen for controlling the air conditioners may differ from the color indicating the “ON” state of the mode and the color indicating the “OFF” state of the mode used for the screen for controlling the water heater. Furthermore, it is also permissible that the first to third colors used for the screen for controlling the air conditioners may be the same as the first to third colors used for the screen for controlling the water heater while the color indicating the “ON” state of the mode and the color indicating the “OFF” state of the mode used for the screen for controlling the air conditioners may differ from the color indicating the “ON” state of the mode and the color indicating the “OFF” state of the mode used for the screen for controlling the water heater.

### Second Embodiment

In the description of the first embodiment, the target control devices operated by the operation application 400 are the air conditioners and a water heater. The target control device for operation, however, is not limited to air conditioners and a water heater. In a second embodiment, an illumination lamp and a refrigerator are the operation target.

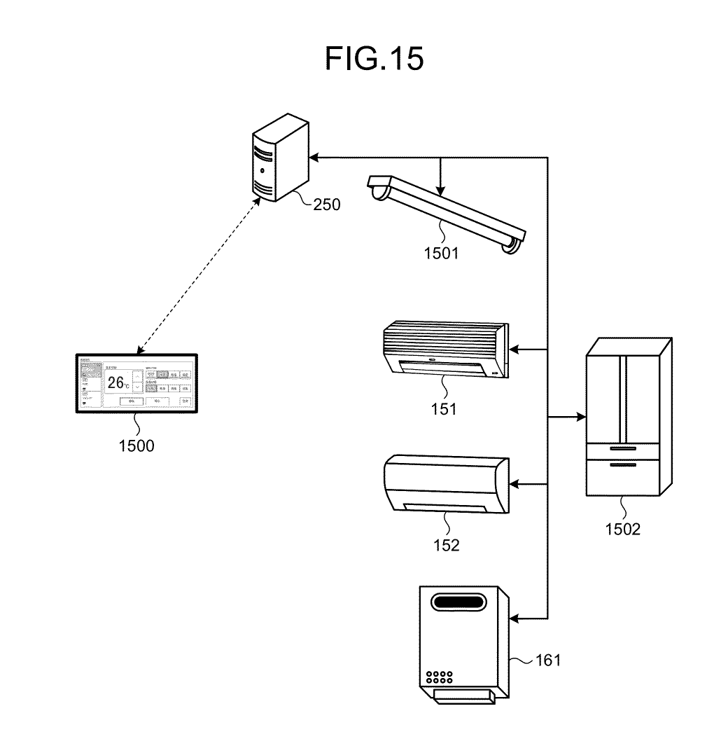

FIG. 15 is a view of a household equipment communications system according to a second embodiment. As illustrated in FIG. 15, an illumination lamp 1501, a first air conditioner 151, the second air conditioner 152, the water heater 161, and a refrigerator 1502 are installed in a house.

A portable communications terminal 1500 can operate target control devices such as the illumination lamp 1501, the first air conditioner 151, the second air conditioner 152, the water heater 161, and the refrigerator 1502. The configuration of the portable communications terminal 1500 is the same as the portable communications terminal 100 in the first embodiment and thus the explanation of the configuration of the portable communications terminal 1500 is omitted.

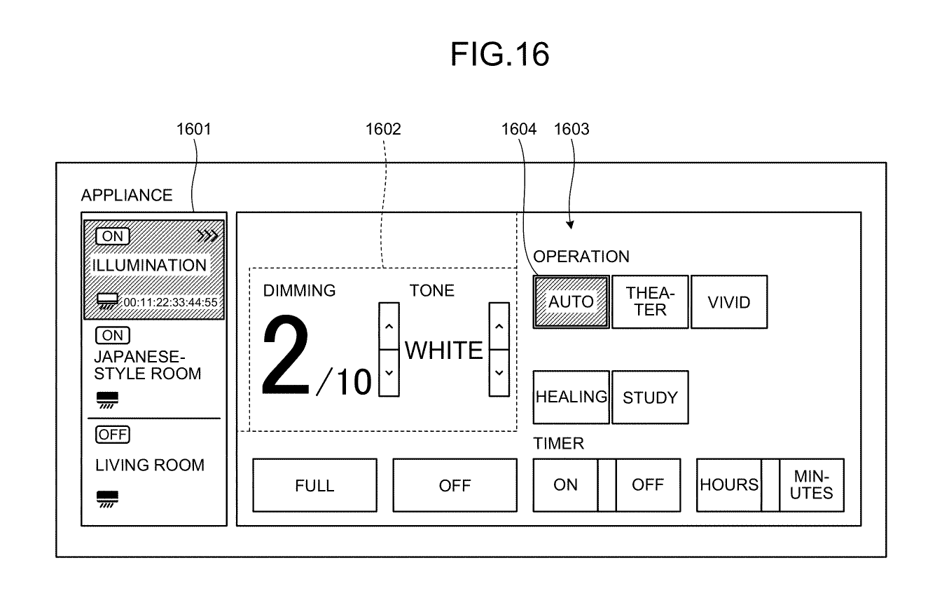

FIG. 16 is a view of an example screen for operating the illumination lamp 1501 displayed by the display controller 404 in the portable communications terminal 1500. The example screen illustrated in FIG. 16 comprises a display area 1601 for selecting an appliance for selecting a target appliance for operation, a display area 1602 for adjusting the dimming and changing the tone of the light, and a display area 1603 for switching modes.

In the display area 1602 for adjusting the dimming and changing the tone of the light, the dimming (brightness) and the tone (color) of the light of the illumination lamp 1501 can be operated. For example, the dimming of the light may be set to a dimming level from 1 to 10, and the tone (color) of the light may be set to a daylight color, a daytime white (neutral white) color, and alight bulb color. The processing procedures when the dimming and the tone of the light are set are the same as the processing procedures illustrated in FIG. 7.

In the display area 1603 for switching modes, any mode can be set to “AUTO”, “THEATER”, “VIVID”, “HEALING”, and “STUDY” modes. In the example illustrated in FIG. 16, an “AUTO” mode 1604 has been set. The processing procedures performed when one of the above-described modes is set are the same as the processing procedures illustrated in FIG. 11.

The portable communications terminal 1500 can also operate the refrigerator 1502. Processing similar to the ones illustrated in FIG. 7 is available for setting the temperature levels for each room in the refrigerator 1502. Processing similar to the ones illustrated in FIG. 11 is available for changing the mode of the entire operation of the refrigerator 1502 out of “NORMAL” and “ECO” modes. In addition, “FREEZE” and “COLD” modes may be switched to each other for each room in the refrigerator 1502 through the processing similar to the ones illustrated in FIG. 11.

According to the above-described embodiments, when setting the temperature of target control devices such as air conditioners and if a temperature change button is pressed, the color for displaying the temperature is changed, whereby a user can recognize that the current operation is related to temperature setting.

According to the above-described embodiments, when changing the temperature setting of a target control device, a change instruction for changing the temperature, for example, is transmitted only after no operation is input for a predetermined time. This can suppress increase of the communication traffic caused by the change instructions for changing the temperature.

According to the above-described embodiments, when the portable communications terminal receives an operation from a user, the display on the portable communications terminal is changed immediately after receiving the transmission of an instruction to the target control device or the reception of a response to the instruction. This enables the user to recognize that the setting of the target control device is received, whereby the convenience of the target control device is improved.

According to the above-described embodiments, when any one of the mode buttons is pressed, the color for displaying the button is changed before the response from the target control device is received. This enables the user to recognize that the portable communications terminal 100 has received the operation for changing the mode. Accordingly, repeated pressing operation on the same button by the user is suppressed, thereby reducing the load of processing.

According to the above-described embodiments, if the control on the target control device fails, an error message is displayed on the display screen of the portable communications terminal, thereby enabling the user to recognize the reason for returning the display to the state before the operation.

According to the above-described embodiments, when switching the target appliance for operation to another target control device, the animation display is used so that a display area in the operation screen moves in a sliding manner. This enables the user to visually recognize that the target control device targeted for operation is switched to another target control device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communications device comprising:
a receiver configured to receive, when first information indicating a setting on a target control device targeted for operation is displayed in a first color in a first display area of a display device, an operation for changing information displayed in the first display area from the first information to second information;
a transmitter configured to transmit to the target control device, after a first time has elapsed from when the receiver has received the operation, an instruction for changing the setting according to the second information; and
a display configured to display, when the receiver has received the operation for changing the information displayed in the first display area and before the transmitter transmits the instruction, the second information in a second color different from the first color in the first display area, and to display, upon transmission of the instruction by the transmitter, the second information in a third color different from the second color in the first display area.

2. The communications device of claim 1, wherein the third color displayed on the display is the same as the first color.

3. The communications device of claim 1, wherein the display is configured to display a second display area different from the first display area in an “OFF” state color indicating that a first setting corresponding to the second display area is not currently activated,
the receiver is configured to further receive an operation to activate the first setting corresponding to the second display area,
the display is configured to display, upon receipt of the operation to activate the first setting corresponding to the second display area by the receiver, the second display area in an “ON” state color indicating that the first setting corresponding to the second display area has been activated, and
the transmitter is configured to transmit to the target control device an instruction for activating the first setting after the display displays the second display area in the “ON” state color.

4. The communications device of claim 1, further comprising a second receiver configured to receive control completion information indicating that the setting corresponding to the instruction is successfully activated from the target control device after the transmitter transmits the instruction, wherein
the display is configured to change the color of the second information displayed in the first display area to the first color from the third color upon receipt of the control completion information by the receiver.

5. The communications device of claim 1, wherein
the receiver is configured to further receive an operation for switching the target control device for operation to another target control device in a third display area, and
the display is configured to display, upon receipt of an operation with respect to the third display area by the receiver, a display area comprising the first display area and the second display area with animation display.

6. A communications system comprising:
a plurality of target control devices; and
a communications device configured to operate at least one of the target control devices as an operation target, the communications device comprising:
a receiver configured to receive, when first information indicating a setting on a target control device targeted for operation is displayed in a first color in a first display area of a display device, an operation for changing information displayed in the first display area from the first information to the second information;
a transmitter configured to transmit to the target control device that is the operation target, after a first time has elapsed from when the receiver has received the operation, an instruction for changing the setting according to the second information; and
a display configured to display, when the receiver has received the operation for changing the information displayed in the first display area and before the transmitter transmits the instruction, the second information in a second color different from the first color in the first display area, and to display, upon transmission of the instruction by the transmitter, the second information in a third color different from the second color in the first display area.
